(19) United States
(12) Patent Application Publication
(10) Pub. No.: US 2013/0168071 A1
(43) Pub. Date: Jul. 4, 2013

(54) 3D POROUS MATERIAL COMPRISING MACHINED SIDE

(71) Applicants: Johan Hugelier, Harelbeke (BE); Peter De Jaeger, Waarmaarde (BE); Johan Priem, Roeselare (BE)

(72) Inventors: Johan Hugelier, Harelbeke (BE); Peter De Jaeger, Waarmaarde (BE); Johan Priem, Roeselare (BE)

(73) Assignee: UNIVERSITEIT GENT

(21) Appl. No.: 13/698,544

(22) PCT Filed: Apr. 26, 2011
(86) PCT No.: PCT/EP11/56535

§ 371 Date: Nov. 16, 2012

(30) Foreign Application Priority Data
May 20, 2010 (EP) 10163352.7

(51) Int. Cl. F28F 21/08; B23D 45/00; B24B 1/00

(52) U.S. Cl. CPC F28F 21/08; B24B 1/00; B23D 45/00
USPC 165/177; 428/221; 428/156; 428/613; 451/59; 83/13

(57) ABSTRACT

3D porous material comprises at least one machined side. The machined side has a solid percentage Pₛ being (1−Pₒ), said Pₒ is the porosity of the bulk of said 3D porous material and said Pₛ is within the 99.5% confidence interval. The present invention provides the method of manufacturing such 3D porous material. Preferably, the 3D porous material is open cell metal foam. The present invention also provides use of such open cell metal foam in a heat exchanger. The present invention further provides a heat exchanger comprising open cell metal foam.

### TECHNICAL FIELD

The present invention relates to 3D porous material, preferably made of metal; more specific the processing of such 3D porous material pieces.

More in particular, the invention relates to open cell 3D porous metal material, preferably open cell metal foam, and method to cut such open cell 3D porous metal material. Furthermore, the invention also relates to use of open cell 3D porous metal material in a heat exchanger.

The invention further relates to a heat exchanger, heat sink (thermal energy exchanging device in general) comprising open cell 3D porous metal material, preferably open cell metal foam.

### BACKGROUND ART

3D porous materials, with a porosity of 80% or more, are used in many industrial and consumer applications. Examples of such 3D porous materials comprise honeycomb structures in polymer or metal materials, open and closed cell foam in polymer or metal materials, a carbon or graphite foam; a carbon or graphite containing metal foam; open cell metal foam as described e.g. in EP1227908; a woven or knitted 3D textile in polymer, metal, graphite or carbon; a 3D wire structure made of polymer, metal, graphite or carbon, such as e.g. the Kagome structure or similar 3D-structures as described in WO2005/044483. Such 3D porous materials are commonly used as strong and lightweight supports, cushioning and impact absorbing materials, filter materials, in heat exchange applications and etc.

Such 3D porous materials are always required to be cut into desired shape, e.g. cylinder. Using conventional cutting methods like band sawing, the surface of 3D porous material after cutting is damaged. Parts of the machined surface are melted, struts can stick out above the machined surface and/or holes can be present under the machined surface. It becomes more and more important to find a 3D porous material with good machined surface and find a suitable cutting method to manufacture the machined surface.

Heat exchangers may be used to transfer heat energy from one fluid to another. In common use, metal heat exchangers are utilized to minimize the thermal resistance between the fluids and the materials they interface with.

Conventional heat transfer devices and assemblies generally include a metal block, machined or extruded fins bonded to a metal plate, a heat spreader, or a tube that is in direct contact with a heat-generating or carrying component. To improve upon conventional designs, 3D porous materials, like e.g. metal foam, are used in place of the extended surface devices as a convection element, with a higher surface area to volume ratio compared to conventional materials. This reduces both the volume and the weight of the heat transfer device or assembly.

Conventional extended-surface heat sinks are commonly made of good thermal conductors, such as copper or aluminium so that heat from the hot component can be readily transferred through the solid structure, entrained, and conducted away by a cooling fluid. Forced convection from a fan or blower is often used to increase the temperature gradient between the air and the heated surface and thereby increase the convective heat transfer coefficient.

In order to address heat transfer challenges, recent developments include devices that use 3D porous materials, such as e.g. high porosity reticulated aluminium, copper and graphite foams, to enhance the heat conducting surface area. The enhanced surface area and tortuous flow paths of air through the solid matrix reduces the convective resistance in heat transfer devices and overcomes the limitations on available surface area per unit volume and avoid complicated machining or manufacturing processes.

U.S. Pat. No. 6,142,222 discloses a plate tube exchanger using open cell metal foam to conduct heat from liquid to gas or gas to gas. The open cell metal foam is required to perform well in heat exchanging, and the heat is conducted from the fluid (either gas or liquid) in the tube to the surface of the tube, then to the metal foam then to the liquid in the metal foam. To manufacture such tube exchanger, the open cell metal foam is cut to fit the tube wall surface. The direct contact between the open cell metal foam and the tube wall is strictly required. The struts of the open cell metal foam are used to conduct the heat from the tube wall into the solid matrix and eventually transfer the heat into the gas flowing through the metal foam structure. To increase the effectivity of heat exchange, the number of cell struts of open cell metal foam in contact with the tube wall needs to be maximized. With conventional cutting technology, it is difficult to obtain maximum contact.

It has been noticed that machining or cutting of 3D porous materials with a porosity of more than 80% is not easy, as in some instances material is lost or material is bent or compressed or even locally melted. Commonly such 3D porous materials are cut by heated wire for polymer materials, and common circular saw or band saw for metal materials; to get the desired shape, for e.g. heat exchanger, sandwich panel, . . . . The cut surface of such 3D porous materials tends to be uneven and unpredictable due to the high porosity which makes the cutting or machining process difficult. The metal melts as the temperature increases while cutting, or the material can be removed due to cutting or machining.

### DISCLOSURE OF INVENTION

It is an object of the present invention to provide a 3D porous material having at least 80% porosity with at least one machined side, e.g. open cell metal foam.

It is another object of the present invention to provide a method of manufacturing the 3D porous material with at least one machined side.

It is a further object of the present invention to provide the use of open cell metal foam in heat exchange.

It is yet a further object of the present invention to provide a heat exchanger comprising open cell metal foam.

According to the first object of the present invention, 3D porous material having at least 80% porosity comprises at least one machined side. The machined side has a solid percentage Pₛ being (1−P_{O}), wherein Pₒ is the porosity of the bulk of said 3D porous material and Pₛ is within the 99.5% confidence interval.

Because its 3D structure, 3D porous material comprises a plenty of solid parts and void parts which are interlaced with each other. The machined side of has 3D porous material solid parts and void parts too. The solid percent Pₛ is defined as the ratio of the solid area of the machined side to the surface area of the machined side. The porosity Pₒ is defined as the ratio of the volume of voids to the total volume of the 3D porous material.

As the machined side is cut well, the surface of machined side is very smoothly without too many struts, holes and material melting.

The machined side is formed by cutting 3D porous material. E.g. open cell metal foam is cut to get a desired shape to fit the requirement of heat exchanger. The side caused by cutting is called machined side.

For structures with normally distributed porosity in their homogeneous regions (thus not taking heterogeneity or anisotropy in account), standard deviation is defined as the square root of the sum of the squared differences of the individual measured values with the mean value of the population, divided by the number of measurements minus 1.

$$s = \sqrt{\frac{1}{N - 1} {\sum }_{i = 1}^{N} {( {x}_{i} - \overline{x} )}^{2}}$$

(wherein xᵢ are the individual measured values and x̅ is the average value of the population).

99.5% confidence interval is taken in the classical statistical sense, meaning it is the interval comprising 2.81 times the standard deviation around the average measured value.

The machined side of 3D porous material with Pₛ within the 99.5% confidence interval means that the surface of machined side has the similar structure of the bulk of the 3D porous material, and is up to the requirement from the customer. There are little or no melted parts or holes or raised parts on the surface of machined side, and the shape of the 3D porous material is correct. For open cell 3D porous material, a good surface ensures that there are a limited number of deformed foam struts and air gaps on the surface of the machined side. This results in a good contact between heat source and open cell metal foam, as well as improved flow properties. Thus the machined side fits perfectly to the surface of heat source which is needed to remove the excess heat. The heat can be conducted more easily from the heat source to the cooling fluid through foam struts which are in close contact with the heat source. Furthermore, the cooling fluid can easily flow through the open cell metal foam for there is a limited amount of deformation of the foam cells.

Even for open cell metal foam, a smooth surface is quite fit for thermal application. Sometimes the open cell metal foam is bonded to the heat transfer by brazing. While brazing the open cell metal foam to heat transfer, the gap between open cell metal foam and heat transfer is required to be very small, and the surface of open cell metal foam and the surface of heat transfer are required to be very smooth and be fit for each other. To the present invention of open cell metal foam, the bonding effect with heat transfer is better, and the heat transferring effect is better because of its uniform and smooth surface.

Preferably the machined side has a substantially flat surface. It means that the machined side has a good flatness, i.e. low surface roughness. The surface roughness is defined as the distance from the plane just touching the 3D porous material until the parallel plane where no sawing effects are seen. The smaller this distance, the better the surface roughness. A better surface roughness means that the cutting method has little influence on the structure of the machined side and the structure of the machined side is nearly the same as the structure of the bulk of 3D porous material.

According to the present invention, the distance is 0.7 mm. Preferably, the distance is 0.5 mm. Even more preferably, distance is 0.2 mm.

Preferably for the machined side, the solid percent Pₛ ranges from 0.80×(1−Pₒ) to 1.20×(1−Pₒ). It means that the surface of the machined side has substantially the same ratio of solid metal to voids as the inside or bulk of the 3D porous material. The cutting method has little influence on the structure of the machined side.

Preferably, the 3D porous material has at least two machined sides which have a substantially flat surface. Especially to open cell metal foam, these two machined sides fit well to the surface of a flat heat source, such as a flat tube.

Preferably, the two machined sides are substantially parallel. ‘Substantially parallel’ means that both the planes of the machined sides of the 3D porous material are under an angle of 3°, more preferably within 1.5°, most preferably below 0.1°.

Furthermore, the machined side can have a curved surface. Different from substantially flat surface, the curved surface means that the surface is smooth but not in one plane. To open cell metal foam, this kind of machined side fits well to the surface of a curved heat source, such as a round tube.

Preferably, the pores per inch (ppi) value is ranging between 5 and 100 ppi. More preferably, the ppi value is ranging between 10 and 40 ppi. Even more preferably, the ppi value is ranging between 10 and 20 ppi.

3D porous material is made of metal or polymer. The metal or polymer can be any kind of metal or polymer known by a person skilled in the art. Preferably 3D porous material is open cell 3D porous material or closed cell 3D porous material. More preferably 3D porous material is open cell 3D porous material.

Preferably, open cell 3D porous material is open cell metal foam.

Pₒ, the porosity of open cell metal foam, is more than 85%. Preferably Pₒ is between 85% and 95%. To open cell metal foam, the porosity provides a direct and immediate cooling for the heat exchanger.

The open cell metal foam is made of a heat conducting metal, such as aluminium, aluminium alloy, copper, copper alloy, nickel, magnesium or graphite. Preferably, the open cell metal foam is made of aluminium or an aluminium alloy. The term “open cell metal foam” is to be understood as metal foam with interconnecting porosity. Such metal foams are e.g. described in EP1227908.

The open cell metal foam can be attached in the heat exchanger by sintering, brazing, welding, co-casting or thermally conductive means. These thermally conductive means can be a thermally conductive glue, a thermally conductive epoxy, paste or thermally conductive metal layer or gap filling materials.

According to the second object of the invention, a method of manufacturing 3D porous material with at least one machined side is provided. The method comprises following steps:
providing 3D porous material,
cutting 3D porous material by fixed abrasive sawing wire thereby obtaining a machined side has a solid percentage Pₛ being (1−Pₒ), wherein Pₒ is the porosity of the bulk of the 3D porous material and Pₛ is within the 99.5% confidence interval.

Using the above method, a substantially flat or curved surface on the machined side can be obtained.

Preferably, 3D porous material is open cell metal foam.

Mostly, compared with open cell 3D porous material, the cell walls of closed cell 3D porous material give more support against deformation while being cut. Thus the cutting surface is smoother and the cutting equipment and method is easier to find out. But for open cell 3D porous material such as open cell metal foam, it is hard to obtain a substantially smooth surface by conventional cutting method such as blade sawing, because the cell walls are weak and do not provide enough support against deformation while suffering cutting. The present invention provides an efficient cutting method for open cell 3D porous material such as open cell metal foam of cutting by fixed abrasive sawing wire. The cutting surface of open cell 3D porous material has a quite flat surface without too many struts, holes or agglomerations caused by melting of material.

The fixed abrasive sawing wire is a kind of sawing wire as e.g. described in U.S. Pat. No. 6,070,570, EP0243825, EP0982094, U.S. Pat. No. 6,102,024, EP0081697 and many more. The abrasive particles such as diamond, cubic boron nitride, tungsten carbide, silicon carbide, aluminium oxide or silicon nitride or a mixture thereof are fixed to the wire via a metal binding layer such as nickel, aluminum, tin or copper, or using a polymer binding layer such as phenol formaldehyde, epoxy, cyanate ester, acrylate, or other known resin by a person skilled in the art.

The fixed abrasive sawing wire can provide a smooth and high quality surface on the machined side of the 3D porous material, e.g. open cell metal foam. High quality of cutting means that the solid percent of the machined side Pₛ being (1−Pₒ), wherein Pₒ being the porosity of the bulk of the 3D porous material and Pₛ being within the 99.5% confidence interval. Open cell metal foam with a high quality cut performs well when used in a heat exchanger.

It's an important advantage that the fixed abrasive sawing wire can provide a substantially flat or curved machined side on the 3D porous material surface thanks to the flexible character of the fixed abrasive sawing wire. The fixed abrasive sawing wire can be used in a curved cutting way to get a curved surface or in a straight cutting way to get a substantially flat surface.

Furthermore, the overall diameter of the fixed abrasive sawing wire (including abrasive particles) is only 100 micron to 350 micron which means that the material loss due to cutting is strongly reduced compared to conventional cutting methods such as a common circular saw or band saw.

Another method of manufacturing 3D porous material with at least one machined side is also provided. The method comprises following steps:
providing 3D porous material,
cutting 3D porous material by silicon carbide circular saw blade thereby obtaining a machined side which has a solid percentage Pₛ being (1−Pₒ), wherein Pₒ is the porosity of the bulk of the 3D porous material and Pₛ is within the 99.5% confidence interval.

The silicon carbide circular saw blade which is different from general circular saw blade comprises SiC particles embedded in a carrier. It can provide a substantially flat surfaced machined side to the 3D porous material.

According to the third object of the invention, use of open cell metal foam in a heat exchanger is provided. Open cell metal foam put in the heat exchanger provides an improved heat transfer effect thanks to the increased surface area. The heat exchange can be presented between two fluids such as gas and liquid or gas and gas.

A heat exchanger is provided according to the last object of the invention. The heat exchanger comprises of at least one open cell metal foam with at least one machined side and at least one tube. At least part of the surface of the tube is connected with the surface of the machined side of open cell metal foam. The heat is conducted from the fluid in the tube to fluid in open cell metal foam through the solid struts of the open cell metal foam. Using open cell metal foam with a high quality cut results in improved heat conduction and convection compared to prior open cell metal foam.

The tube in the heat exchanger can be a flat tube or a round tube of which the surface fits well with the substantially flat surface or curved surface of machined side of the open cell metal foam. This leads to the improved heat conduction and convection.

Such open cell metal foam with at least one machined side can be used in any heat exchanger which has corresponding surface to connect with.

### BRIEF DESCRIPTION OF DRAWINGS

Example embodiments of the invention are described hereinafter with reference to the accompanying drawings in which

FIG. 1 shows a three-dimensional view of open cell metal foam with a machined side having substantially flat surface.

FIG. 2 shows a three-dimensional view of closed cell metal foam with a machined side having curved surface.

FIG. 3 shows a three-dimensional view of open cell metal foam with a machined side having round surface.

FIG. 4 shows a three-dimensional view of open cell polymer foam with a machined side having curved surface.

FIG. 5 shows a three-dimensional view of open cell metal foam with two machined sides having substantially flat surface.

FIG. 6 shows an exemplary heat exchanger.

FIG. 7 shows a graph of 10 ppi open cell metal foam cut in several machining methods indicating the Pₛ from the bulk of the material going to the machined side.

FIG. 8 shows a graph of 20 ppi open cell metal foam cut in several machining methods indicating the Pₛ from the bulk of the material going to the machined side.

### MODE(S) FOR CARRYING OUT THE INVENTION

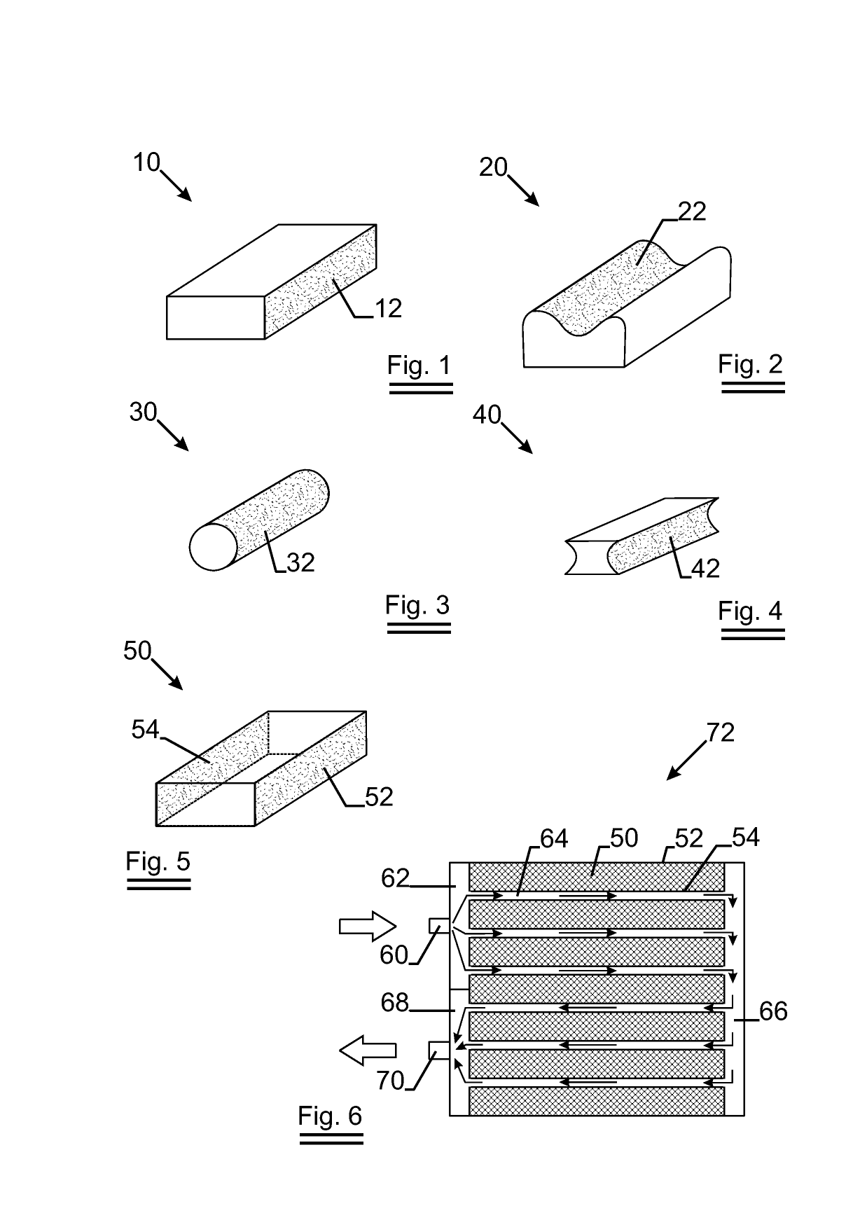

FIG. 1 illustrates the first embodiment of the present invention. Open cell metal foam 10 made of aluminium has a machined side 12 which has a substantially flat surface. The solid percent Pₛ of the machined side 12 is 6.1% while the porosity Pₒ of open cell metal foam 10 is 94%. PPI of open cell metal foam 10 is 10 ppi.

To get the machined side 12, open cell metal foam 10 which is formed by casting aluminium in a known way is cut by fixed abrasive sawing wire which has a diameter of 250 micron and a tensile strength of 2200N/mm².

FIG. 2 illustrates the second embodiment of the present invention. Closed cell metal foam 20 which is made of aluminium has a machined side 22. The machined side has a curved surface. The solid percent Pₛ of the machined side 22 is 40.3% while the porosity Pₒ of closed cell metal foam 20 is 60%.

FIG. 3 illustrates the third embodiment of the present invention. Open cell metal foam 30 made of copper has a machined side 32. The machined side 32 is circular. The solid percent Pₛ of the machined side 32 is 7.5% while the porosity Pₒ of open cell metal foam 30 is 93%. PPI of open cell metal foam 30 is 20 ppi.

FIG. 4 illustrates the fourth embodiment of the present invention. Open cell polymer foam 40 has a machined side 42 which has a curved surface. The solid percent Pₛ of the machined side 42 is 14.2% while the Pₒ of open cell polymer foam 40 is 86%.

FIG. 5 illustrates the fifth embodiment of the present invention. Open cell metal foam 50 has two machined sides 52 and 54. The two machined sides 52 and 54 are parallel to each other. The solid percent Pₛ of the machined side 52 is 5.2%, and the solid percent Pₛ of the machined side 54 is 5.3%, wherein the porosity Pₒ of open cell metal foam 50 is 95%. PPI of open cell metal foam 50 is 25 ppi.

All the embodiments above have the Pₛ being within 99.5% confidence interval of (1−Pₒ).

A comparison test is carried out between the present invention open cell metal foam 10 and prior art open cell metal foams A, B and C all of which have a machined side with flat surface. The test is testing the solid percent of the machined sides which are formed in different ways from the same kind of open cell metal foams. The machined side of open cell metal foam A is formed by circular saw, the machined side of open cell metal foam B is formed by spark erosion, and the machined side of open cell metal foam C is formed by band saw. Table 1 summarizes the test result.

TABLE 1

| Open cell metal foam | 10 | A | B | C |
|---|---|---|---|---|
| Pₒ | 94% | 94% | 94% | 94% |
| PPI | 10 | 10 | 10 | 10 |
| Pₛ | 6.1% | 14.5% | 8.9% | 4.2% |
| Pₛ/(1 − Pₒ) | 1.02 | 2.42 | 1.48 | 0.70 |

Another comparison test is carried out between the present invention open cell metal foam 50 and prior art open cell metal foams A, B and C. All of the above open cell metal foams have two parallel machined sides which are formed in different ways. The test is testing the solid percent of the machined sides. The machined sides 52 and 54 of open cell metal foam 50 are formed by fixed abrasive sawing wire. The machined sides of open cell metal foam D are formed by circular saw, the machined sides of open cell metal foam E are formed by spark erosion, and the machined sides of open cell metal foam F are formed by band saw. Table 2 summarizes the test results.

TABLE 2

| Open cell metal foam | 50 | D | E | F |
|---|---|---|---|---|
| Pₒ | 95% | 95% | 95% | 95% |
| PPI | 20 | 20 | 20 | 20 |
| Pₛ of one machined side(Pₛ₁) | 5.2% | 8.9% | 7.4% | 6.5% |
| Pₛ of one machined side(Pₛ₂) | 5.3% | 9.0% | 7.3% | 6.6% |
| Pₛ₁/(1 − Pₒ) | 1.04 | 1.78 | 1.48 | 1.3 |
| Pₛ₂/(1 − Pₒ) | 1.06 | 1.8 | 1.46 | 1.32 |

For both Table 1 and Table 2, Pₛ of the machined side was measured by CT scan with steps of 37.5 μm in the depth.

Both Table 1 and Table 2 show that the solid percent Pₛ of the machined side of present invention is most close to the value of (1−Pₒ), within 99.5% confidence interval. It means that the machined side has the similar structure with the area of open cell metal foam where no sawing effects are seen. There is limited number of deformed foam strut and air gap at the surface of the machined side. Using open cell metal foam of the present invention, an excellent contact with the heat source can be obtained via the surface of the machined side.

FIG. 6 illustrates a heat exchanger comprising open sell metal foam. The heat exchanger 72 comprises a fluid inlet 60, an inlet tank 62, plate tubes 64, open cell metal foams 50, a tank 66, an outlet tank 68, and a fluid outlet 70. The fluid flows into the fluid inlet 60 and goes through the inlet tank 62, then goes through the plate tubes 64 which are communicated with the inlet tank 62 and thereby carry out heat exchange with a fluid which perpendicularly transfers in the open cell metal foam 50. The machined sides such as machined sides 52 and 54 connect with the surface of plate tubes 64 quite well. Then the fluid goes through the tank 66, and then goes through the plate tubes which are communicated with the outlet tank 68. Finally the fluid goes out of the heat exchanger via the fluid outlet 70.

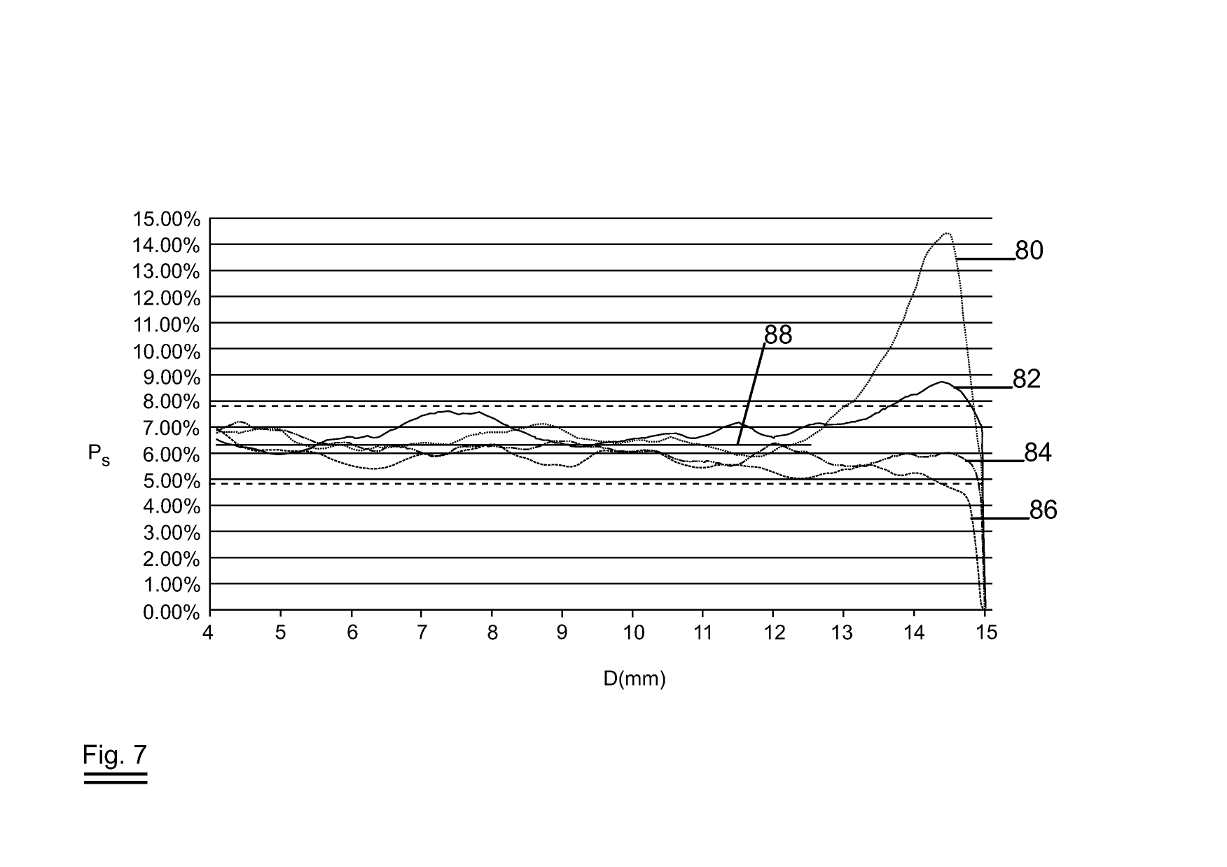

FIG. 7 shows the Pₛ of open cell metal foam with 10 ppi from inside of the bulk of the material going to the machined side. All the data are obtained by CT scan with steps of 37.5 μm in the depth for open cell metal foam cut in different way. Curve 80 shows the CT scan for the open cell metal foam cut by circle saw, curve 82 shows the CT scan for the open cell metal foam cut by band saw, curve 84 shows the CT scan for the open cell metal foam cut by fixed abrasive sawing wire, curve 86 shows the CT scan for the open cell metal foam cy by spark erosion, and curve 88 shows the mean. In the graph, D means the distance from the location of CT scan to one reference parallel plane inside the bulk of open cell metal foam, and the machined side has the biggest D value. The two dotted lines mean the maximum and minimum value of 99.5% confidence interval. From the graph, especially from the part having D value of from 13 to 15 mm, it is obvious that the machined side cut by fixed abrasive sawing wire has the best Pₛ. The cutting method has little influence on the surface of the machined side. At the surface of machined side, Pₛ is very close to the mean porosity.

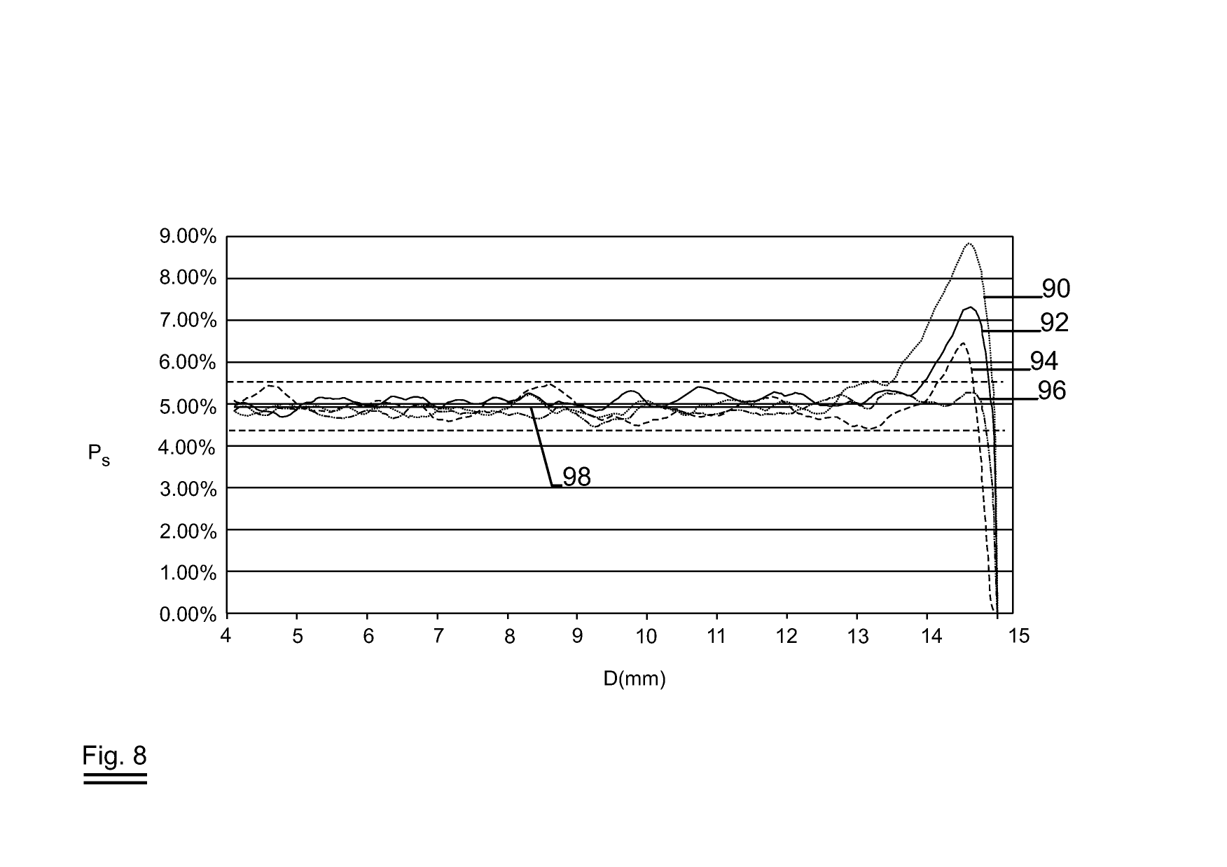

FIG. 8 shows the Pₛ of open cell metal foam with 20 ppi from inside of the bulk of the material going to the machined side. All the curves are measured by CT scan with steps of 37.5 μm in the depth for open cell metal foam cut in different way. Curve 90 shows the CT scan for the open cell metal foam cut by circle saw, curve 92 shows the CT scan for the open cell metal foam cut by band saw, curve 94 shows the CT scan for the open cell metal foam cut by spark erosion, curve 96 shows the CT scan for the open cell metal foam cy by fixed abrasive sawing wire, and curve 98 shows the mean. In the graph, D means the distance from the location of CT scan to one reference parallel plane inside the bulk of open cell metal foam, and the machined side has the biggest D value. The two dotted lines mean the maximum and minimum value of 99.5% confidence interval. From the graph, especially from the part having D value of from 13 to 15 mm, it is obvious that the machined side cut by fixed abrasive sawing wire has the best Pₛ, closest to the mean. This cutting method has little influence on the surface of the machined side.

1. 3D porous material having at least 80% porosity, said material comprising at least one machined side, characterized in that said machined side has a solid percentage Pₛ being (1−Pₒ), said Pₒ is the porosity of the bulk of said 3D porous material and said Pₛ is within the 99.5% confidence interval.

2. 3D porous material as claimed in claim 1, characterized in that said machined side has a substantially flat surface.

3. 3D porous material as claimed in claim 2, characterized in that said 3D porous material has at least two said machined sides.

4. 3D porous material as claimed in claim 3, characterized in that said two said machined sides are substantially parallel.

5. 3D porous material as claimed in claim 1, characterized in that said machined side has a curved surface.

6. 3D porous material as claimed in claim 1, characterized in that said 3D porous material is open cell 3D porous material.

7. 3D porous material as claimed in claim 6, characterized in that said open cell 3D porous material is open cell metal foam.

8. 3D porous material as claimed in claim 7, characterized in that said Pₒ of said open cell metal foam ranges from 85% to 95%.

9. 3D porous material as claimed in claim 7, characterized in that said open cell metal foam is made of aluminium or aluminium alloy.

10. A method for manufacturing 3D porous material with at least one machined side, said method comprising following steps:
providing 3D porous material,
cutting said 3D porous material by fixed abrasive sawing wire thereby obtaining a machined side which has a solid percentage Pₛ being (1−Pₒ), said Pₒ is the porosity of the bulk of said 31) porous material and said Pₛ is within the 99.5% confidence interval.

11. A method as claimed in claim 10, characterized in that said machined side has a substantially flat surface or a curved surface.

12. A method as claimed in claim 10, characterized in that said 3D porous material is open cell metal foam.

13. A method for manufacturing 3D porous material with at least one machined side, said method comprising following steps:
providing 3D porous material,
cutting 3D porous material by silicon carbide circular saw blade thereby obtaining a machined side which has a solid percentage Pₛ being (1−Pₒ), said Pₒ is the porosity of the bulk of said 3D porous material and said Pₛ is within the 99.5% confidence interval.

14. Use of open cell metal foam as claimed in claim 7 in a heat exchanger.

15. A heat exchanger comprising open cell metal foam as claimed in claim 7, said heat exchanger further comprising at least one tube, characterized in that said surface of said machined side of said open cell metal foam is connected to at least part of the surface of said tube.
